(19) United States
(12) Patent Application Publication
(10) Pub. No.: US 2017/0000107 A1
(43) Pub. Date: Jan. 5, 2017

(54) Methods Of Manufacturing An Electrified Deterrent Device Having An Insulative Layer

(71) Applicant: Bird-B-Gone, Inc., Mission Viejo, CA (US)

(72) Inventor: Bruce Donoho, Mission Viejo, CA (US)

(21) Appl. No.: 15/266,608

(22) Filed: Sep. 15, 2016

Related U.S. Application Data
(62) Division of application No. 14/213,406, filed on Mar. 14, 2014.
Application No. 14/213,406 is a continuation-in-part of application No. 14/098,182, filed on Dec. 5, 2013.
(60) Provisional application No. 61/733,841, filed on Dec. 5, 2012.

(51) Int. Cl. A01M 29/26; B29C 37/00; B29C 65/56; B29C 47/00

(52) U.S. Cl. CPC A01M 29/26; B29C 47/0019; B29C 37/0025; B29C 65/565; B29K 2995/0005; B29L 2031/34

(57) ABSTRACT

Methods of manufacturing an electric deterrent device for birds or other pests are described that include extruding an elongated base having upper and lower surfaces, coupling first and second conductors to the elongated base, and coating at least a portion of the lower surface of the elongated base with a non-adhesive coating. The step of coating the elongated base can include coating at least part of the upper and/or lower surfaces.

This application is a divisional application of U.S. utility application having Ser. No. 14/213406, filed on Mar. 14, 2014, which is a continuation-in-part application of U.S. utility application having Ser. No. 14/098182, filed on Dec. 5, 2013, and which claims priority to U.S. Provisional Application No. 61/733,841, filed on Dec. 5, 2012. These and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling

### FIELD OF THE INVENTION

The field of the invention is deterrent devices for birds or other pests.

### BACKGROUND

The following description includes information that may be useful in understanding the present invention. It is not an admission that any of the information provided herein is prior art or relevant to the presently claimed invention, or that any publication specifically or implicitly referenced is prior art.

U.S. Pat. No. 7,481,021 to Riddell discusses electric deterrent devices having a non-conductive base to which conductive elements can be attached, typically via sewing the conductive element to the base. The devices are problematic because the thread used for sewing is exposed on the bottom surface of the device and can come into contact with water. The water can then seep up the thread and contact the conductive element, thereby potentially shorting the system. Another problem with the Riddell device and other devices is that as the conductive element is sewn to the device, one or more strands of the conductive element can be pushed downward and out of a bottom surface of the device. These strands, when the device is installed, can contact the perch surface and potentially short the system.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Thus, there is still a need for electric deterrent devices that mitigate the above problems.

### SUMMARY OF THE INVENTION

The inventive subject matter provides apparatus, systems and methods in which electric deterrent devices can be insulated from water or a perch surface, for example, via a coating on a bottom surface and/or other portion of the devices. In some contemplated embodiments, the entire surface, or almost the entire surface, of a device can be coated. Preferred devices include an elongated base having one or more conductors coupled to an upper surface of the base.

In some contemplated embodiments, a fastener can be used to couple a conductor to the base. In such embodiments, it is preferred that the coating covers at least a portion of the fastener.

Exemplary electric deterrent devices are described in U.S. Pat. Nos. 7,481,021, 8,196,340, 7,802,396, 7,937,885, 8,020,340, 8,015,747, and 8,196,341. Although the systems and methods described herein are especially useful with deterrent devices having a flat, lower surface (i.e., non-grooved or indented), it is contemplated that the systems and methods could be used with both devices having indentations (e.g., those devices described in U.S. Pat. Nos. 8,196,340, 7,802,396, 7,937,885, 8,020,340, 8,015,747, and 8,196,341) and those without indentations (e.g., those devices described in U.S. Pat. No. 7,481,021)

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a vertical cross-section view of one embodiment of a deterrent device.

FIGS. 2-3 are vertical cross-section views of the deterrent device of FIG. 1 comprising a coating.

FIG. 4 is a vertical cross-section view of another embodiment of a deterrent device having a trough on a bottom surface.

FIGS. 5-6 are vertical cross-section views of the deterrent device of FIG. 4 comprising a coating.

FIG. 7A illustrates one embodiment of a deterrent device to be coated by dipping the deterrent device into a coating.

FIG. 7B illustrates a vertical cross-section view of the deterrent device of FIG. 7A having a coating.

FIG. 8 illustrates a vertical cross-section view of another embodiment of a deterrent device having a coating.

FIG. 9 illustrates one embodiment of a system for coating deterrent devices.

FIGS. 10-11 illustrate vertical cross-section views of other embodiments of deterrent devices having a coating.

FIG. 12 illustrates one embodiment of a method for coating a deterrent device.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

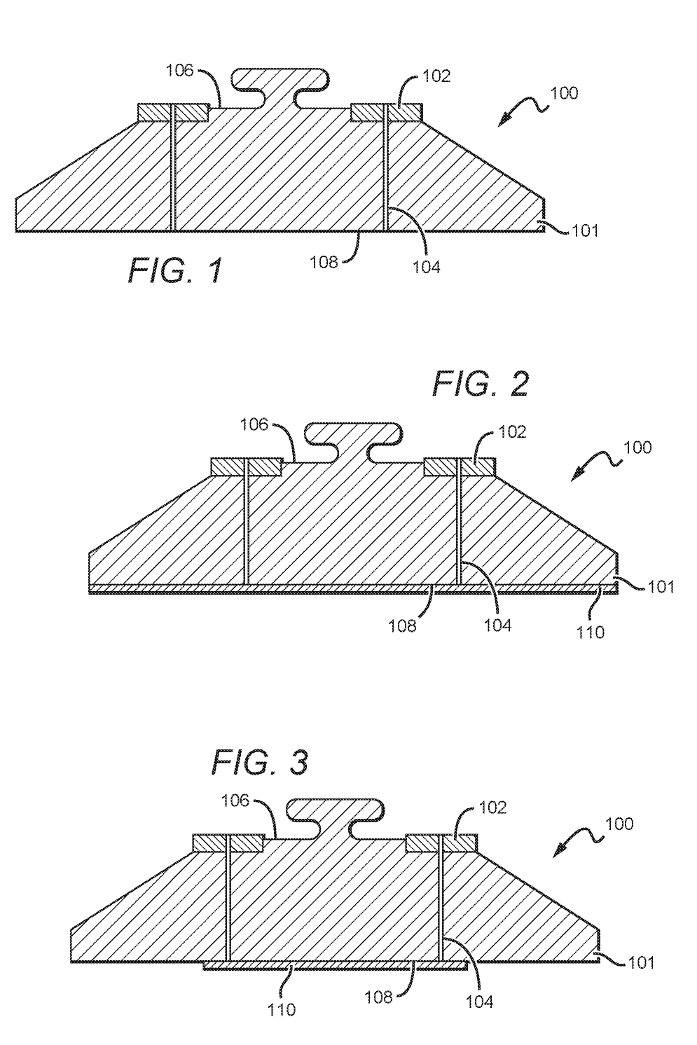

FIG. 1 illustrates an electric deterrent device 100 having a flat, lower surface 108 (e.g., lacking a trough or indentation). Device 100 can include an elongated base 101 and can include one or more conductors 102 (conductive traces) coupled to an upper surface 106 of the base 101. Preferably, the conductors are coupled to the base 101 via sewing although any commercially suitable methods for coupling the conductors could be used. When sewn, it is preferred that a fastener 104 extends from the conductor 102 to a lower surface 108 of the base 101.

To facilitate insulation of the fastener 104 and/or conductor 102, a coating 110 can be applied to at least a portion of a lower surface 108 of the device 100, as shown in FIG. 2 and FIG. 3. The coating 110 advantageously can be used to insulate new and existing deterrent devices and thereby help prevent shorting of systems utilizing the deterrent devices. For example, where the conductor 102 is sewn to the base 101 using a fastener 104, the coating 110 could be disposed over a seam formed on the lower surface 108 of the base 101 to thereby insulate the seam from water and the mounting or perch surface. This is critical in preventing water from contacting the seam and seeping up to the conductor, thereby potentially shorting the system.

In addition, the coating 110 can be used to help prevent contact of stray conductive elements from conductor 102 that may extend out from a lower surface 108 of the device 100, usually as a result of the process of sewing the conductor 102 to the base 101. In this manner, the coating 110 can also prevent shorting of systems utilizing the device 100 by helping to prevent any stray conductive elements from contacting the mounting or perch surface.

Any commercially suitable coating could be used including liquids and semi-solid coatings. Thus, for example, the coating could comprise a spray that when dried provides a sufficient barrier against water from contacting a fastener and/or conductive element. In other contemplated embodiments, the coating could comprise a foam that acts as an insulative layer. However, the coating is expressly defined to exclude glue or other adhesive that may be applied when installing the device to a mounting surface.

Although it is contemplated that the coating 110 could be applied along the entire length of a lower surface 108 of the base 101 and elsewhere, it is alternatively contemplated that the coating 110 could be applied only to desired areas, such as where a fastener forms a seam on a lower surface 108 or in a trough/indentation, for example. Of course, during the coating process, it is also possible that the entire length will not be coated either intentionally or due to the manufacturing process. For example, although it may be unintentional, it is possible that a small fraction of the entire length may not be coated due to the manufacturing process.

The height or thickness of the coating 110 can vary depending on the device and application, but in some contemplated embodiments, the height/thickness of the coating 110 could be less than 1 mm, or between about 1 mm-3 mm. However, the specific height/thickness of the coating 110 should be sufficient to help prevent contact of a fastener or stray conductive element with a perch or mounting surface, and particularly water that can pool on the surface. Of course, it is also contemplated that the coating's height may vary along a length of the device, either intentionally or as a result of the coating process.

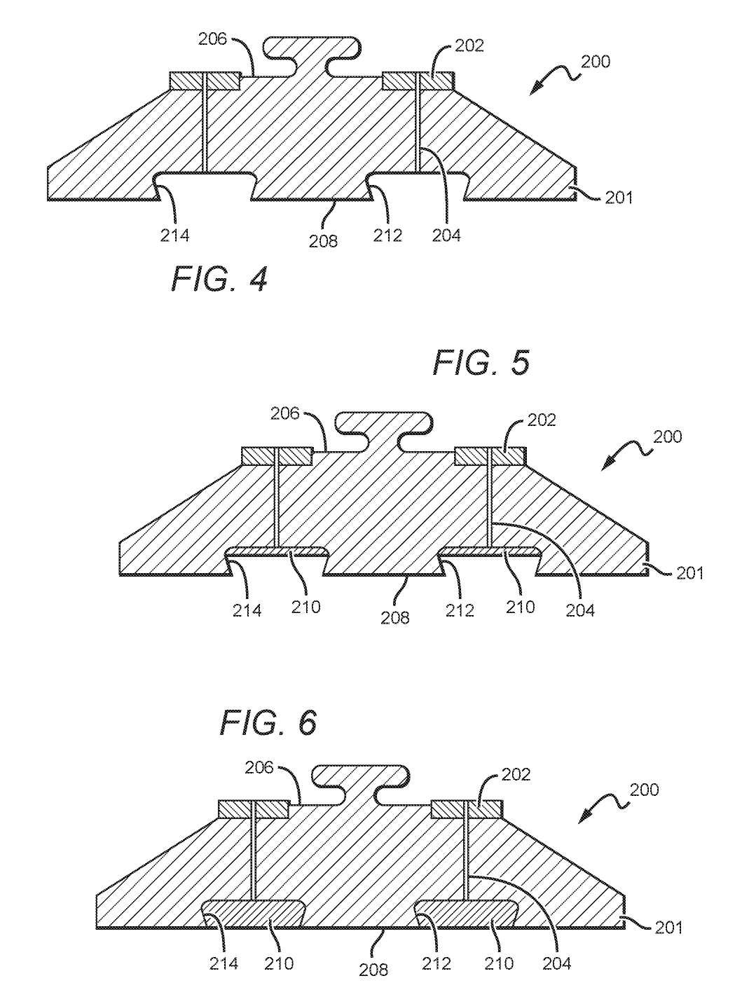

FIG. 4 illustrates another embodiment of an electric deterrent device 200 having an elongated base 201 with first and second troughs 212 and 214 formed on a lower surface 208 of the base 201. Device 200 can include one or more conductors 202 (conductive traces) coupled to an upper surface 206 of the base 201. Preferably, the conductors are coupled to the base 201 via sewing although any commercially suitable methods for coupling the conductors could be used. When sewn, it is preferred that the first fastener 204 extends from the first conductor 202 to the first trough 212, and the second fastener 216 extends from the second conductor 202 to the second trough 214.

FIG. 5 and FIG. 6 illustrate the device 200 of FIG. 4 having a coating 210 within at least a portion of the indentations or troughs 212 and 214. Contemplated coatings are described above in relation to FIGS. 1-3 and are not reiterated here. The coating can cover all or part of the lower surface of the base 201, which includes the first and second troughs 212 and 214. Of course, although two troughs are shown, it is contemplated that the base 201 could include a single trough disposed on a lower surface of the base 201.

In addition to, or in the alternative to a coating, the base can be configured to receive a carrier on to which the base is mounted. In such embodiments, the carrier can act as an insulator, thereby helping to prevent the fastener(s) from contacting water that may pool on a mounting surface. The carrier could be snap-fitted to the base, or could be fixedly attached such as via glue or other adhesive. Of course, any commercially suitable methods for coupling the components could be used without departing from the scope of the inventive subject matter described herein.

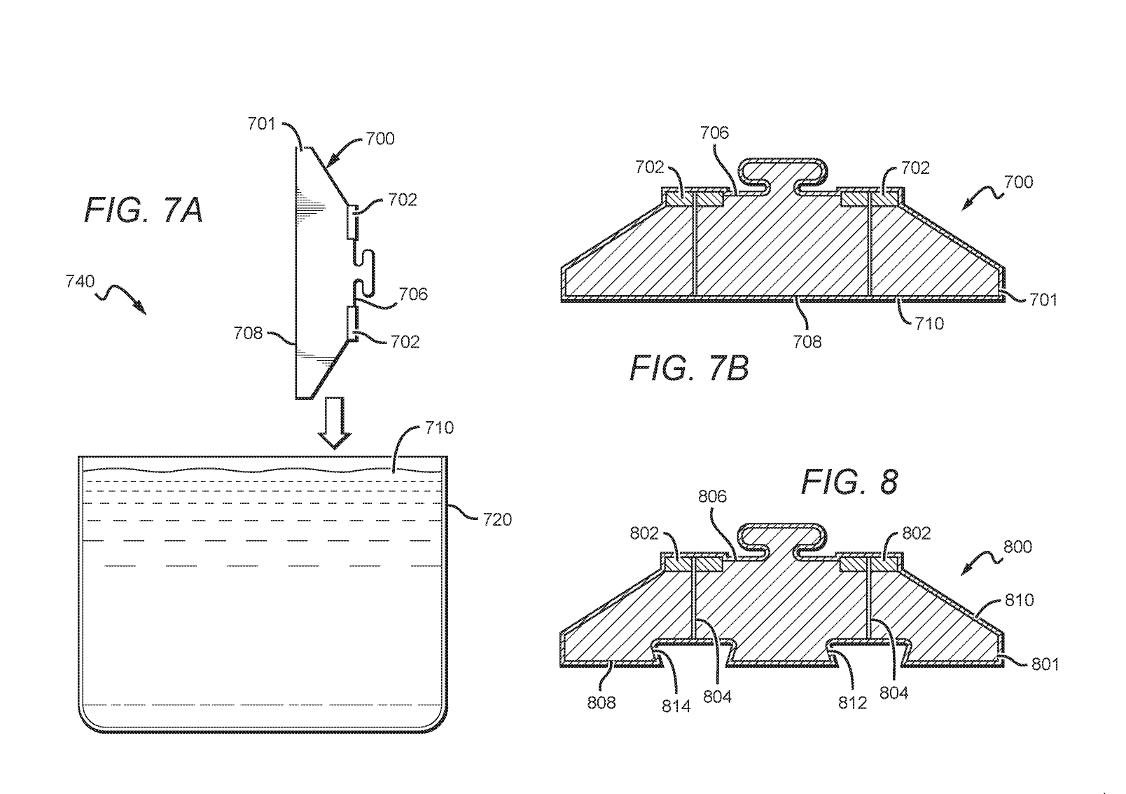

FIG. 7A illustrates one embodiment of a system 740 for coating a deterrent device 700. System 740 could comprise a container 720 that stores a coating 710. To coat a device 700, for example, all or a portion of the device 700 could be submerged into the coating 710. Although device 700 is shown having a base 701 to which conductors 702 are coupled, it is contemplated that the device 700 could be coated prior to the conductors 702 being coupled to the upper surface 706 of base 701. Although shown without indentations on bottom surface 708, it is contemplated that the base 701 could include indentations.

FIG. 7B illustrates deterrent device 700 having a coating 710 disposed on the exposed surfaces of the base 701 as well as the exposed surfaces of conductors 702. In such embodiment, it is likely that the coating 710 will cover substantially all, if not all, of the exposed surface of the fastener. As used herein, the term “exposed surface” means those surfaces of a device or otherwise that would be exposed to a coating when the device encounters the coating such as via submersion into a coating, spray coating, or via other commercially suitable applications for coating the device. With respect to the remaining numerals in each of FIGS. 7A-7B, the same considerations for like components with like numerals of FIG. 1 apply.

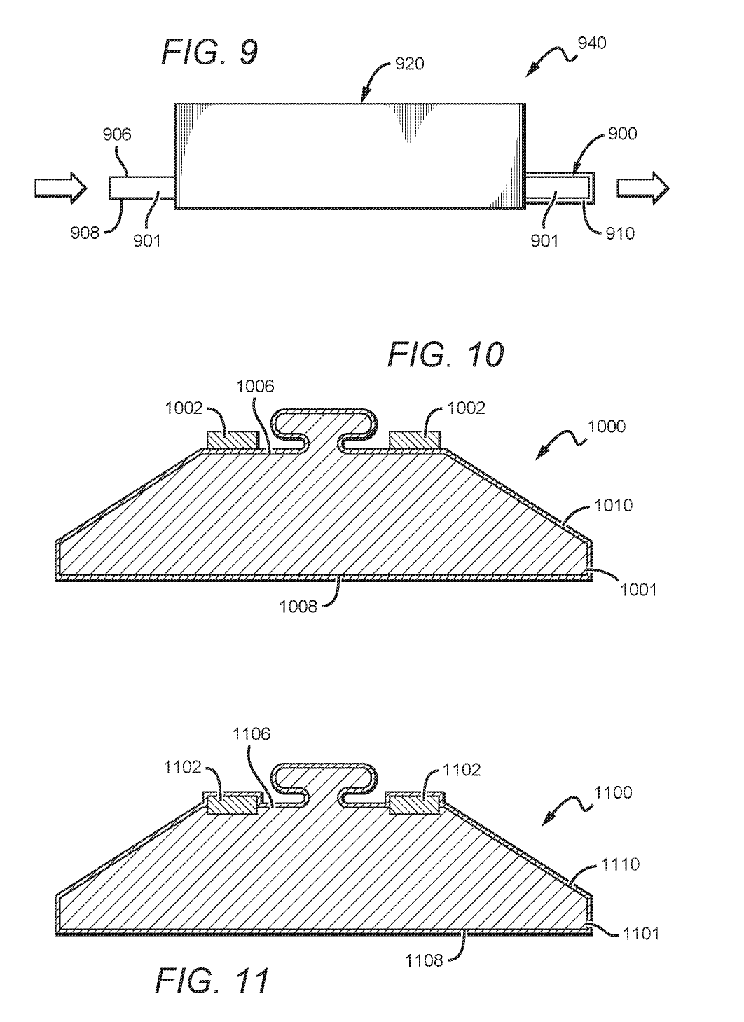

FIG. 8 illustrates another embodiment of an electric deterrent device 800 having an elongated base 801 with first and second indentations 812 and 814 disposed on the base's lower surface 808. Conductors 802 can be coupled to the base's upper surface 806, and are preferably coupled via a sewn thread. However, any commercially suitable fastener, or method of fastening the conductors 802 to the base 801, could be used. When sewn, it is preferred that each fastener 804 extends from a conductor 802 to an indentation 812 or 814. Device 800 further includes a coating 810 that cover substantially all, if not all, of the exposed surface of the base 801, as well as at least a top portion of conductors 802. Contemplated coatings are described above in relation to FIGS. 1-3 and are not reiterated here.

FIG. 9 illustrates one embodiment of a system 940 for coating a deterrent device 900 having an elongated base 901. Device 900 can pass through a spray coater 920 or other commercially suitable device configured to coat all, or a portion of, the device 900, such that the device 900 exits with a coating 910 on at least a portion of its exterior surface. In embodiments using a spray coater, it is contemplated that one or more spray nozzles could be used that could be disposed to spray on a single side of the device 900 or about the device in multiple locations. For example, in some contemplated embodiments, spray nozzles could be disposed above and below the device 900 such that all or some of the top and bottom surfaces of the device 900 are coated.

FIG. 10 illustrates another embodiment of an electrical deterrent device 1000 having an elongated base 1001 with conductors 1002 coupled to the base's upper surface 1006. Device 1000 further includes a coating 1010 that cover substantially all, if not all, of the exposed surface of the base 1001. Contemplated coatings are described above in relation to FIGS. 1-3 and are not reiterated here. In this embodiment, the base 1001 is coated prior to the conductors 1002 being coupled to the base 1001. In such embodiments, it is further contemplated that a second coating could be applied, if desired, such that all or a portion of the exposed surfaces of the conductors 1002 are coated.

FIG. 11 illustrates yet another embodiment of an electrical deterrent device 1100 having an elongated base 1101 to which conductors 1102 can be coupled. Rather than sewing the conductors 1102 to the base's upper surface 1106, conductors can be coupled to the base 1101 via friction-fit or thermal coupling, for example. As shown in FIG. 11, each conductor 1102 can be at least partially embedded into an upper surface 1106 of base 1101. Device 1100 can further include a coating 1110 that cover substantially all, if not all, of the exposed surface of the base 1101 as well as a top surface of conductors 1102. Contemplated coatings are described above in relation to FIGS. 1-3 and are not reiterated here.

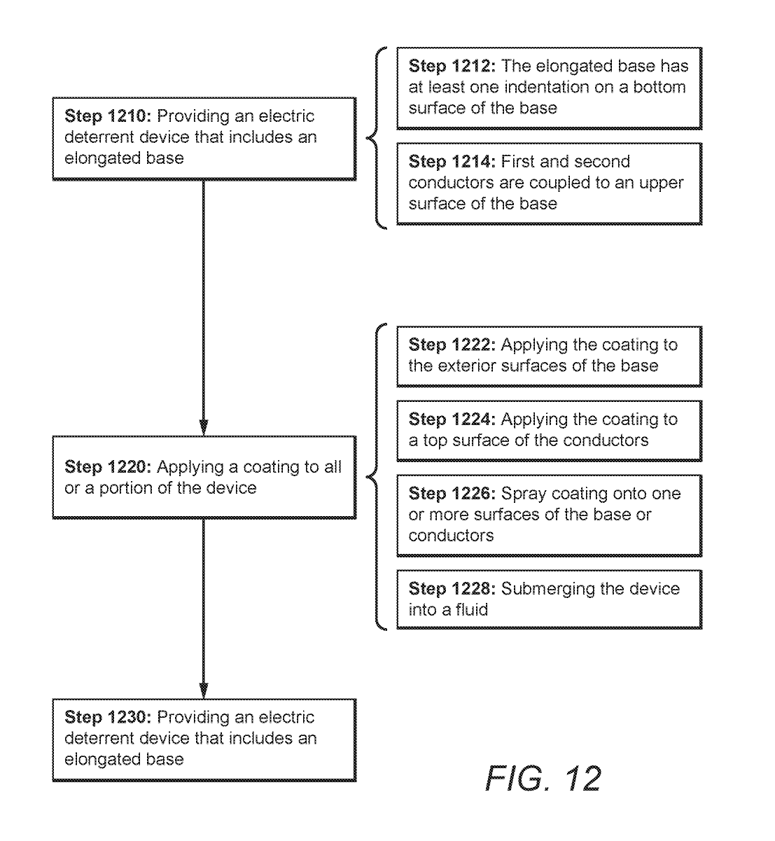

FIG. 12 illustrates one embodiments of a method 1200 for coating an electrical deterrent device. In step 1210, an electric deterrent device can be provided that includes an elongated base. In some contemplated embodiments, shown in step 1212, the elongated base can include at least one indentation on a bottom surface of the base. In further contemplated embodiments, shown in step 1214, first and second conductors can be coupled to an upper surface of the elongated base.

In step 1220, a coating can be applied to all or a portion of the device. In step 1222, the coating can be applied to the exterior surfaces of the base. In step 1224, the coating can be applied to a top surface of the conductors. In step 1226, the coating can be sprayed onto one or more surfaces of the base and/or conductors. In such embodiments, it is contemplated that the device could pass through a spray coater where the device can be sprayed with a coating on all or a portion of the device's surfaces.

In step 1228, the device can be submerged into a fluid to thereby coat the device.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of manufacturing an electric deterrent device, comprising:
extruding an elongated base having upper and lower surfaces;
coupling first and second conductors to the upper surface of the base; and
coating at least a portion of the lower surface of the base with a non-adhesive coating.

2. The method of claim 1, wherein the step of coupling the first and second conductors comprises sewing the first and second conductors to the upper surface of the base.

3. The method of claim 1, wherein the step of coupling the first and second conductors to the upper surface of the base comprises using a friction-fit to couple the first and second conductors to the upper surface of the base.

4. The method of claim 1, wherein the step of coupling the first and second conductors comprises thermally coupling the first and second conductors to the upper surface of the base.

5. The method of claim 1, wherein the step of coating at least the portion of the lower surface of the base comprises spraying the non-adhesive coating on at least the portion of the lower surface of the base.

6. The method of claim 5, wherein the step of spraying the non-adhesive coating comprises spraying the non-adhesive coating on the lower surface of the base to form a layer on the lower surface of the base.

7. The method of claim 6, further comprising spraying the non-adhesive coating on at least a portion of the upper surface of the base.

8. The method of claim 5, wherein the step of spraying the non-adhesive coating comprises spraying the non-adhesive coating on the upper and lower surfaces of the base.

9. The method of claim 1, wherein the step of coating at least a portion of the lower surface of the base comprise submerging at least the portion of the lower surface of the base in a fluid.

10. The method of claim 1, wherein the step of coating at least the portion of the lower surface of the base comprise submerging the base and the conductor coupled to the base in a fluid.
